(19) United States
(12) Patent Application Publication
(10) Pub. No.: US 2014/0006117 A1
(43) Pub. Date: Jan. 2, 2014

(54) PERSONALIZED REORDER POINT BASED ADVERTISEMENT

(71) Applicants: Barry A. Kritt, Raleigh, NC (US); Sarbajit K. Rakshit, Kolkata (IN)

(72) Inventors: Barry A. Kritt, Raleigh, NC (US); Sarbajit K. Rakshit, Kolkata (IN)

(73) Assignee: INTERNATIONAL BUSINESS MACHINES CORPORATION, Armonk, NY (US)

(21) Appl. No.: 13/539,105

(22) Filed: Jun. 29, 2012

(51) Int. Cl. G06Q 10/08; G06Q 30/02

(52) U.S. Cl. 705/14.4

(57) ABSTRACT

A method for determining a reorder point tracks a purchase of one of a product and a service by a consumer. The product or service is purchased by the consumer online. The method determines a rate of consumption for the product or service. The method determines a reorder point for the product or a service. The reorder point includes an estimated time after the purchase of the product or service and prior to, based on the rate of consumption, the product or service reaching a safety stock level, minus a replenishment lead time. The safety stock level is a minimum acceptable level of a quantity of remaining product or service due to be delivered. The method delivers an advertisement to the consumer. The advertisement is delivered to the consumer electronically and the advertisement is delivered to the consumer at a time relative to the reorder point.

### FIELD

The subject matter disclosed herein relates to reordering products or services and more particularly relates to determining a reorder point for a product or service.

### BACKGROUND

### Description of the Related Art

Many vendors advertise products and services to increase sales. Advertising, once limited to print, television, and radio ads, is rapidly changing. Today numerous new avenues of advertising are available, including email, internet pop-up ads, text messages, and other forms of electronic delivery. With so many avenues of advertising and so many advertisements bombarding consumers daily, it is easy for consumers to tune out advertising. Vendors are constantly seeking alternate ways to make sure that their message is heard.

Targeted advertising is one way that vendors try to reach their target audience. For example, if consumer actions can be tracked through a browser or cookies placed on a computer of the consumer to glean habits and preferences of the consumer. If the consumer clicks on a certain website, makes a particular purchase, etc. cookies and browsing history may be accessed to determine the consumer's preferences and vendors can target those preferences. In one example, if a consumer clicks on websites related to fly fishing or make a purchase of fly fishing equipment, the consumer's preference for fly fishing can be exploited and vendors selling fly fishing gear can target the consumer with advertising. However, while this type of targeted advertising targets consumer preferences, the targeted advertising may not address timing of purchases and may not address purchase of products that are reordered.

### BRIEF SUMMARY

A method for determining a reorder point and advertising related to the reorder point is disclosed. An apparatus and computer program product also perform the functions of the method. The method, in one embodiment, includes tracking a purchase of one of a product and a service by a consumer. The purchase includes a quantity so that the product or service is replenished to a substantially full level. The product or service is offered for sale online and the product or service purchased by the consumer online. The method includes, in an embodiment, determining a rate of consumption for the product or service.

The method includes determining a reorder point for the product or a service. The reorder point includes an estimated time after the purchase of the product or service and prior to, based on the rate of consumption, the product or service reaching a safety stock level, minus a replenishment lead time. The safety stock level may be a minimum acceptable level of a quantity of remaining product or service due to be delivered. The method includes delivering an advertisement to the consumer. The advertisement is delivered to the consumer electronically and the advertisement is delivered to the consumer at a time relative to the reorder point.

In one embodiment, tracking a purchase further includes tracking a plurality of purchases of the product or service and storing purchase information in an order history. In a further embodiment, the method includes adjusting the rate of consumption based on the order history. In another embodiment, the method includes storing the order history of the consumer on a computer readable storage medium of a vendor that sold the product or service to the consumer. In another embodiment, the method includes storing the order history of the consumer on a computer readable storage medium accessible to the consumer. Where the order history is stored on a computer readable medium accessible to the consumer, in one embodiment the order history is maintained and updated with additional purchases of the product or service by the vendor selling the product or service to the consumer.

In another embodiment, the order history comprises purchasing the product or service from a plurality of vendors and each vendor contributes to the order history. In one embodiment, each vendor contributes to the order history by one or more cookies stored on the computer readable storage medium of the consumer and the cookies are shared cookies. In the embodiment, the method includes determining the reorder point from the order history of the shared cookies.

In one embodiment, tracking the order history includes tracking an inventory of the product with an inventory tracking system. In another embodiment, determining the reorder point further includes determining an unusable point when the product or service will no longer be usable and adjusting the reorder point if the unusable point is prior to the time of reaching the safety stock level and/or the reorder point. In another embodiment, the reorder point includes a time prior to an estimated out of stock level. The out of stock level may include a time when the product will be completely consumed by the consumer or the service is completed. In a further embodiment, the method includes delivering a plurality of advertisements to the consumer where the advertisements change focus at the reorder point, the time of reaching the safety stock level, and/or the out of stock level.

In one embodiment, delivering the advertisement to the consumer at a time relative to the reorder point includes delivering the advertisement just prior to the reorder point, at the reorder point, and/or just after the reorder point. In another embodiment, the product includes a consumable product that is reordered by the consumer when the product is consumed. In another embodiment, the service includes a service delivered to the consumer over a period of time and additional service is reordered by the consumer when the service to the consumer is completed.

In one embodiment, the method is implemented with a computer program product. The computer program product includes a computer readable storage medium having computer readable program code embodied therein and computer readable program code configured to execute the steps of the method.

An apparatus for determining a reorder point includes, in one embodiment, a tracking module, a rate module, a reorder point module, and an advertising module. The tracking module tracks a purchase of a product and/or a service. The purchase includes purchasing a quantity so that the product or service is replenished to a substantially full level. The product or service is offered for sale online and the product or service is purchased by the consumer online. The rate module determines a rate of consumption for the product or service.

The reorder point module determines a reorder point for the product or a service. The reorder point includes an estimated time after the purchase of the product or service and prior to, based on the rate of consumption, the product or service reaching a safety stock level, minus a replenishment lead time. The safety stock level is a minimum acceptable level of a quantity of remaining product or service due to be delivered. The advertising module delivers an advertisement to the consumer. The advertisement is delivered to the consumer electronically and the advertisement is delivered to the consumer at a time relative to the reorder point. At least a portion of the modules include logic hardware or executable code stored on computer readable storage media, or both.

In one embodiment, the apparatus includes an order history module that tracks a plurality of purchases of the product or service and stores purchase information in an order history. In another embodiment, the order history module stores the order history on a computer readable storage medium of a vendor that sold the product or service to the consumer. In another embodiment, the order history module stores the order history on a computer readable storage medium accessible to the consumer. In another embodiment, the apparatus includes a cookie module that stores the order history of the consumer on one or more cookies where the cookies are accessible to one or more vendors.

In one embodiment, the apparatus includes an inventory tracking module that tracks an inventory of the product with an inventory tracking system. In another embodiment, the apparatus includes a computer. The computer includes a processor and memory and the processor executes code of one or more of the modules.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for determining a reorder point in accordance with the present invention;

FIG. 2 is a schematic block diagram illustrating one embodiment of an apparatus for determining a reorder point in accordance with the present invention;

FIG. 3 is a schematic block diagram illustrating another embodiment of an apparatus for determining a reorder point in accordance with the present invention;

FIG. 4 is a diagram illustrating one example of determining a reorder point in accordance with the present invention;

FIG. 5 is a schematic flow chart diagram illustrating one embodiment of a method for determining a reorder point in accordance with the present invention;

FIG. 6 is a schematic flow chart diagram illustrating another embodiment of a method for determining a reorder point in accordance with the present invention; and

FIG. 7 is a schematic flow chart diagram illustrating another embodiment of a method for determining a reorder point where multiple vendors store cookies in accordance with the present invention.

### DETAILED DESCRIPTION OF THE INVENTION

A reorder apparatus and method are described, which include tracking purchases of a product or service and then determining a reorder point from the purchase time, a rate of consumption, delivery time, and the like and then basing advertisement timing and content on the reorder point. For example, once a reorder point is established, an advertisement may be sent out ahead of the reorder point and may incentivize reorder. After the reorder point a different advertisement may be sent. In one embodiment, an Economic Order Quantity (“EOQ”) model is used in determining the reorder point.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireline, optical fiber, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product via shared execution, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the computer program product. The summed measurements of use units are periodically multiplied by unit costs and the resulting total computer program product service costs are alternatively sent to the customer and or indicated on a web site accessed by the customer which then remits payment to the service provider.

In one embodiment, the service provider requests payment directly from a customer account at a banking or financial institution. In another embodiment, if the service provider is also a customer of the customer that uses the computer program product, the payment owed to the service provider is reconciled to the payment owed by the service provider to minimize the transfer of payments.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

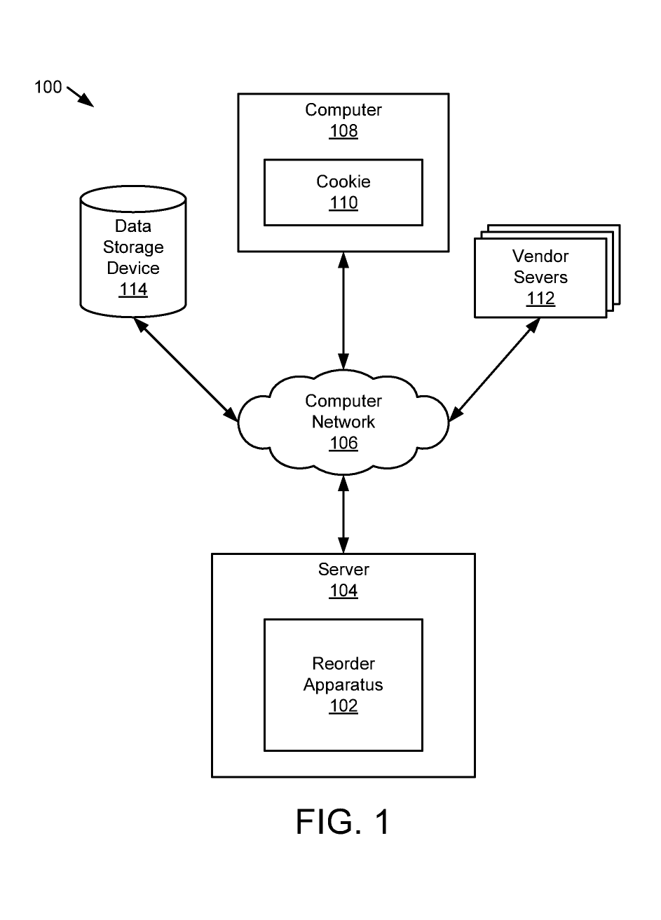

FIG. 1 is a schematic block diagram illustrating one embodiment of a system 100 for determining a reorder point in accordance with the present invention. The system 100 includes a reorder apparatus 102, a server 104, a computer network 106, a computer 108 with a cookie 110, vendor servers 112, and a data storage device 114, which are described below.

The system 100 includes a reorder apparatus 102. In the depicted embodiment, the reorder apparatus 102 is located in a server 104 connected to a computer 108 of a consumer through a computer network 106. In other embodiments, all or part of the reorder apparatus 102 are included in the server 104, the computer 108 of the consumer, a data storage device 114, or other location known to those of skill in the art. In one embodiment, the computer 108 is in communication with the reorder apparatus 102 through the computer network 106 and code is executing or hardware activated in a different location than the computer 108. One of skill in the art will recognize other ways that the reorder apparatus 102 can be distributed and executed. The reorder apparatus 102 is discussed in more detail below with respect to other figures.

In one embodiment, the system 100 includes a server 104 in communication with a computer network 106. The server 104 may be a mainframe, a blade server, a workstation, a desktop computer, or other computer. The server 104, in one embodiment, includes a plurality of processors, such as a partitioned mainframe with multiple operating system instances. In another embodiment, the server 104 includes one or more subsystems, such as a storage area network. The server 104, may access internal storage or external storage accessible through a network. The server 104 may be controlled by a vendor or other party that collects order information.

The system 100 includes a computer network 106. The computer network 106 may include the Internet, a wireless network, a local area network (“LAN”), a wide area network (“WAN”), or other computer network. The computer network 106 may include a combination of networks. The computer network 106 may include switches, routers, servers, or other devices common to a computer network. The system 100 includes a computer 108 accessible by a consumer. The computer 108 may be a laptop computer, a desktop computer, a workstation, a netbook computer, a notebook, a personal digital assistant (“PDA”), a smartphone, or any other device with a processor.

In one embodiment, the computer 108 includes at least one cookie 110 with information regarding a purchase. The cookie 110 may be stored by a vendor selling a product or a service or by another system or service, such as a data collection service, with access to the computer 108. The cookie 110 includes data, such as an order history of a product or service, vendor information, authentication information, or other information known to those of skill in the art. The order history stored in the cookie 110 may include information, such as quantity ordered, date ordered, vendor identification and contact information, or other information useful in determining a reorder point for a product or service.

The system 100, in one embodiment, includes one or more vendor servers 112. The vendor servers 112, in one embodiment, may be typical of the server 104 and may include a reorder apparatus 102 or similar apparatus. Each vendor server 112 may be accessed by the consumer and may be a part of a transaction by the consumer to purchase a product or service. A consumer may be an individual, a family, a group, a company, an organization, or any other entity that may purchase a product or service. In one embodiment, a vendor server 112 may update a cookie 110 with order history information. For example, a vendor server 112 may access a cookie 110 placed by the vendor on the computer 108 to access order history. In another example, the vendor server 112 may access one or more shared cookies 110 placed or updated by the vendor or a different vendor server 112 to assess an order history and to determine a reorder point. One of skill in the art will recognize other forms and uses of a cookie 110 on the computer 108 of a consumer.

The system 100, in one embodiment, includes a data storage device 114 accessible to the computer 108 of the consumer and/or the server 104 through the computer network 106. In one example, the data storage device 114 is considered a cloud computing device and access may be controlled by a server. In another example, the data storage device 114 is part of a storage area network and the computer 108 or server 104 accesses the data storage device 114 through the storage area network. In another embodiment, one or more cookies 110 with order history information is stored on the data storage device 114 and may be accessed by one or more vendors. One of skill in the art will recognize other configurations of a data storage device 114 accessible over a computer network 106.

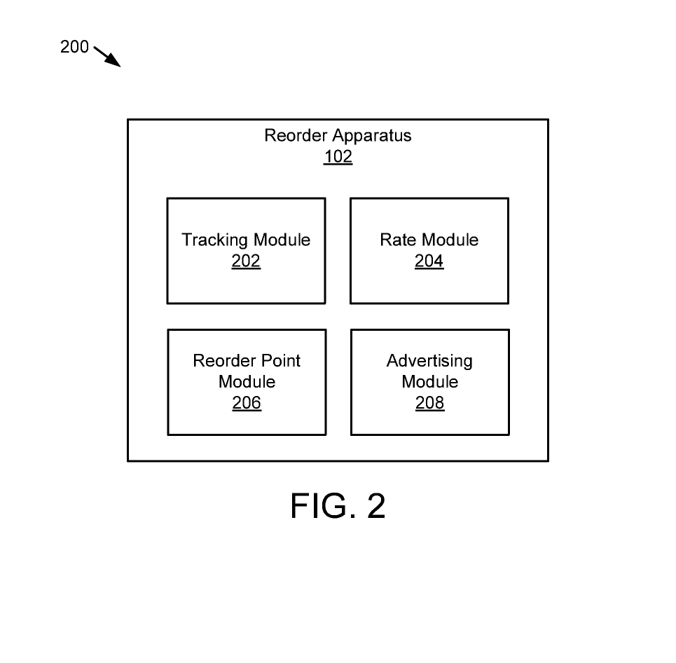

FIG. 2 is a schematic block diagram illustrating one embodiment of an apparatus 200 for determining a reorder point in accordance with the present invention. The apparatus 200, in one embodiment, includes a tracking module 202, a rate module 204, a reorder point module 206, and an advertising module 208, which are described below.

The apparatus 200, in one embodiment, includes a tracking module 202 that tracks a purchase of one of a product and a service by a consumer. In one embodiment, the purchase includes a quantity so that the product or service is replenished to a substantially full level. For example, the purchase may replenish the product or service a little above or below what is considered to be a full level. In a particular embodiment, the purchase is a product. In another embodiment, substantially full is an inventory level where the consumer is satisfied with an inventory level after delivery of the product or service. Typically the product is a type that is consumed and reordered. For example, the product may be a raw material used in a manufacturing process and is periodically reordered. The product may be an industrial product, a consumer good, etc. The product may be, for example, a consumer staple good, like milk, butter, flour, etc. The product may also be something consumed by a business, such as a restaurant, an office, a printing company, or the like. For example, the product may be paper used by an office and the office may periodically reorder paper as the paper supply at the office dwindles. In another example, the product is a single product but is of a nature that the product is periodically replaced. For example, the product may be a toner cartridge of a printer or copier.

In one embodiment, the product is of the nature that the product has a period of usefulness in addition to a rate being used by the consumer. For example, if the product is milk, the milk may be assumed to go sour after a certain date. In another example, the product may be a medicine with an expiration date, bread that goes stale, etc. The length of usefulness of the product may be used along with a rate of use by the consumer, date of purchase, etc. to determine a reorder point.

In another embodiment, the purchase includes a service and the service is of the nature that the service is reordered. For example, the service may be house cleaning services where a certain number of visits are included in the purchase and the consumer reorders additional house cleaning visits as the purchased visits are used. In another example, the service may include washing a vehicle at a car wash facility. The purchase may include a certain number of visits to a car wash facility and the consumer may purchase additional car washes as the purchased visits are used. One of skill in the art will recognize other products and services that may be purchased and reordered.

In one embodiment, the product or service is offered for sale online and is purchased by the consumer online. Hereinafter, the product or service being offered for sale online includes an offer by a vendor to enable a consumer to purchase the product or service online, or at least enables some type of communication from a consumer indicating a commitment to purchase the product or service. The vendor may advertise the product by various means, such as a print ad, a television ad, a radio ad, an email ad, a popup ad on a browser, or any other advertising means available to the vendor. By offering the product for sale online, the vendor enables an online purchase or at least some communication from the consumer that indicates some level of commitment to purchase the product or service from the vendor. In one embodiment, enabling online sales or communication of a commitment of sale may enable a vendor to track the purchase with the tracking module 202. The tracking may be through a cookie 110 or through other records kept by the vendor.

In one embodiment, the apparatus 200 includes a rate module 204 that determines a rate of consumption for the product or service. The rate module 204, in one embodiment, uses a predicted rate for the particular product or service that was purchased by the consumer. In a particular embodiment, the rate module 204 is determined as part of an Economic Order Quantity (“EOQ”) model. In one embodiment, the EOQ may be an order quantity that minimizes total inventory holding costs and ordering costs. In another embodiment, a rate associated with the EOQ may be assumed to be a constant rate or a demand for the product or service is constant over a particular time period. In one embodiment of the EOQ model, the purchase price per unit ordered is assumed to be constant. In another embodiment of the EOQ model, replenishment restores an entire batch at once instead of incrementally. In yet another embodiment of the EOQ model, lead time before replenishment is fixed. Under the above assumptions, one use of the EOQ model may be to determine a balance between quantity on hand, shipping costs, storage costs, etc. to optimize an amount of product or service to be ordered.

The rate module 204 determines a rate based on the product or service purchased. The rate module 204 may use amount of product/service purchased, amount currently available to the consumer, a traditional usage rate of the product or service, a usage rate from the consumer, the EOQ model, etc. For example, the rate module 204 may use a standard rate or an assumed rate initially and may adjust the rate based on information from the consumer. The information from the consumer may include direct information about product usage from the consumer, such as hours of production, a production rate, an amount of the product or service used per unit produced, etc. For example, if an auto maker purchases pallets of plastic from a vendor, information about production of automobiles may be used to determine the rate. For example, the type of information that would be useful in determining a rate may include how many pallets may be enough plastic for X number of cars, how many cars are made hour, production hours at a plant, and the like.

The information from the customer may also include information from an order history and a rate may be adjusted or deduced from two or more purchases of the product or service. For example, from the pallets of plastic example above, if the rate module 204 determines a rate of Y number of pallets of plastic per day, actual order information may indicate a different usage rate and the rate module 204 may adjust the rate. The rate module 204 may use other factors for determining a rate as well, such as experience, known production stoppages, holidays, weekends, etc. One of skill in the art will recognize other ways that the rate module 204 may use previous order information to adjust the rate determined by the rate module 204.

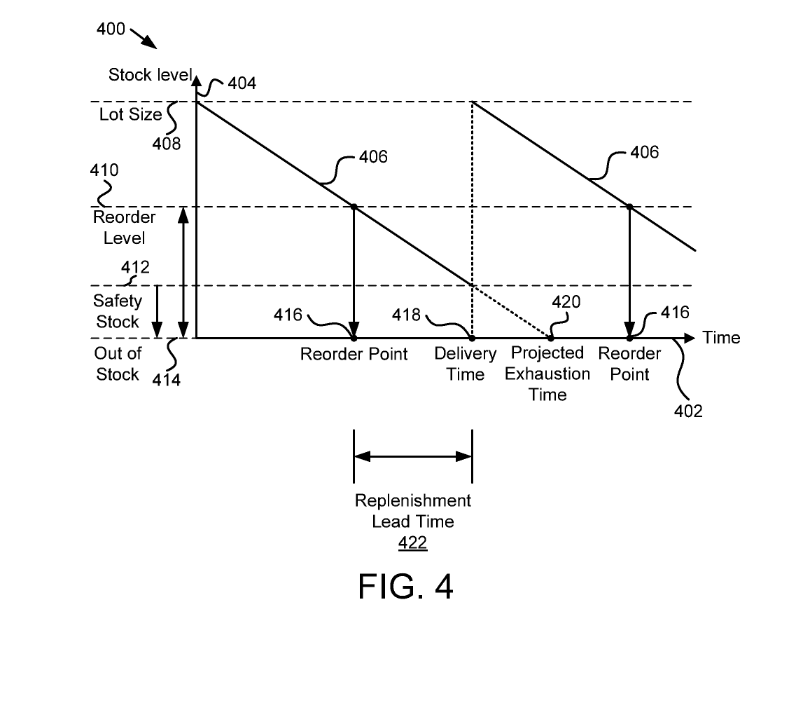

In one embodiment, the apparatus 200 includes a reorder point module 206 that determines a reorder point for the product or a service. In one example, the reorder point is a point where the product or service should be reordered by the consumer to avoid reduction of inventory below a minimum acceptable level. The minimum acceptable level may be called a safety stock level. FIG. 4 is a diagram illustrating one example 400 of determining a reorder point. The example 400 is intended to graphically illustrate one embodiment a reorder point, but other more complex or different rates are also contemplated herein. The example 400 includes a graph with a horizontal X-axis of time 402 and a vertical Y-axis of stock level 404.

The example 400 includes an inventory level 406 indicating that the stock level 404 is decreasing over time 402. In this particular example 400, the inventory level 406 is decreasing at a constant rate. In other examples, the inventory level 406 may decrease at a non-linear rate, for example, taking into account nights, weekends, holidays, differing usage, etc. In one embodiment, the rate is calculated by the rate module 204. A top line indicates a lot size 408, a lower line represents a reorder level 410, and a next lower line represents a safety stock level 412. A stock level 404 indicating out of stock level 414 is at the X-axis. Along the time 402 axis, are reorder points 416, a delivery time 418, and a projected exhaustion time 420. A replenishment lead time 422 is a difference between a reorder point 416 and a subsequent delivery time 418.

The lot size 408, in one embodiment, is a level where an inventory is full or at a level where the consumer is satisfied that the inventor is adequate. In another embodiment, the lot size 408 is the amount of inventory of the consumer at a delivery time 418 plus an amount of product or service delivered at the delivery time 418. In one embodiment, the lot size 408 varies depending upon quantity ordered and an amount of product in inventory at the delivery time 418. The safety stock level 412 is an inventory level that may be considered a minimum acceptable level. For example, the safety stock level 412 may be a level set by a consumer as a minimum level and the product or service must be delivered before the inventory gets lower than the safety stock level 412. In another example, the safety stock level 412 is a level assumed by a vendor to be a minimum level or a level assumed by the vendor to be the consumer's minimum acceptable level. In another example, the safety stock level 412 is the out of stock level 414 or zero inventory. In various embodiments, the out of stock level 414 may be when a product is completely consumed by the consumer, when the product is no longer available to the consumer, when a service is completed, etc.

The reorder level 410 an inventory level corresponding to the reorder point 416 and is a level where the product or service should be ordered, allowing for replenishment lead time 422, such that the inventory does not go below the safety stock level 412. The reorder point 416 is a point in time and, in one embodiment, is the delivery time 418 minus replenishment lead time 422. The delivery time 418 corresponds to a time when the product or service is delivered to the consumer and is projected to be before the inventory level 406 goes below the safety stock level 412. In one embodiment, the reorder point 416 corresponds to when the inventory level 406 decreases to the reorder level 410. The projected exhaustion time 420 is when the inventory level 406 is projected to reach the out of stock level 414 if the inventory is not replenished. Note that the inventory may be product possessed by the consumer or may be an amount of service not yet delivered. In other words, the reorder point 416 includes an estimated time after the purchase of the product or service and prior to, based on the rate of consumption, the product or service reaching the safety stock level 412, minus a replenishment lead time 422.

The replenishment lead time 422, in one embodiment, includes delivery time 418, vendor processing time, order time, and other time necessary for the inventory level 406, as projected, to not dip below the safety stock level 412. The replenishment lead time 422 may include, in one embodiment, time for the consumer to decide to order. In another embodiment, the replenishment lead time 422 includes additional time to allow for delivery or other delays. The replenishment lead time 422, in one embodiment, is estimated by the vendor based on experience, location of the consumer, or other relevant factors.

In one embodiment, the reorder point module 206 determines the reorder point 416 based on a purchase tracked by the tracking module 202 and a rate of consumption determined by the rate module 204. In addition, the reorder point module 206 may use the replenishment lead time 422, the safety stock level 412, or other factors to determine the reorder point 416. One of skill in the art will recognize other factors in determining a rate of consumption.

In one embodiment, the apparatus 200 includes an advertising module 208 that delivers an advertisement to the consumer. In one example, the advertising module 208 delivers the advertisement to the consumer at a time relative to the reorder point 416. The advertising module 208, in one embodiment, delivers the advertisement to the consumer electronically. For example, the advertising module 208 may deliver an advertisement to the consumer by way of an email, a text message, a pop-up ad in a browser, or the like. The advertisement is typically an advertisement for the product or service purchased previously by the consumer. The advertisement may include incentives to the consumer to buy the product, such as a coupon, discount, a list of virtues of the product or service, or other inducement to buy. The advertising module 208, in one embodiment, delivers an advertisement prior to or at the reorder point 416. For example, if a product is purchased by the consumer and then the reorder point module 206 determines that the reorder point 416 is 100 days after a delivery time 418, the advertising module 208 may deliver the advertisement 5 days before the reorder point 416, or, in another example, at the reorder point 416. In another example, the advertising module 208 delivers the advertisement after the reorder point 416. In another example, the advertising module 208 delivers advertising to the consumer at multiple times.

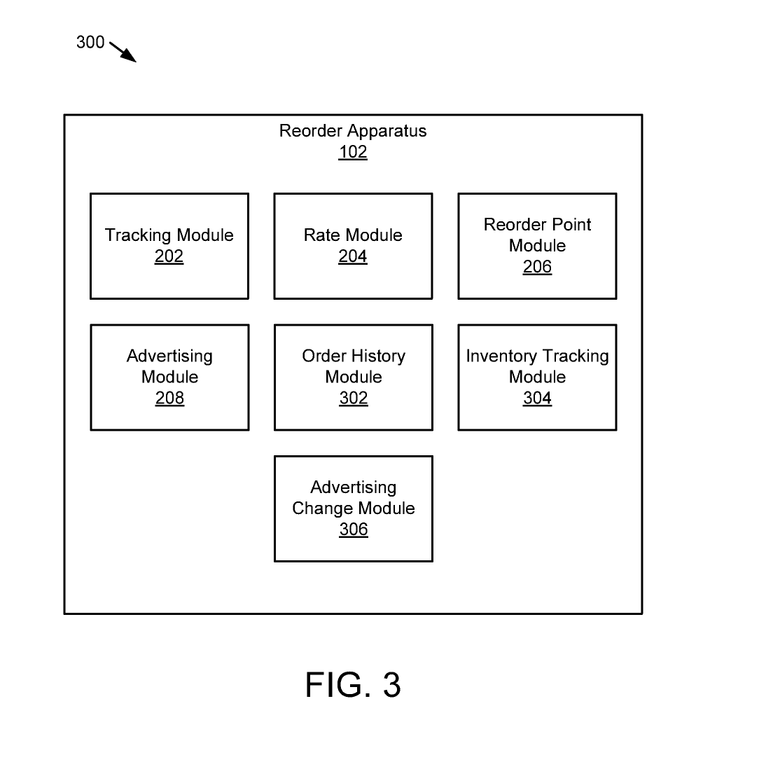

FIG. 3 is a schematic block diagram illustrating another embodiment of an apparatus 300 for determining a reorder point 416 in accordance with the present invention. In one embodiment, the apparatus 300 includes a tracking module 202, a rate module 204, a reorder point module 206, and an advertising module 208, which are substantially similar to those described with respect to the apparatus 200 of FIG. 2. The apparatus 300, in various embodiments, may include an order history module 302, an inventory tracking module 304, and an advertising change module 306, which are described below.

In one embodiment, the apparatus 300 includes an order history module 302 that tracks a plurality of purchases of the product or service and stores purchase information in an order history. In one embodiment, the order history module 302 stores the order history in a computer readable storage media, such as a data storage device, that is accessible to the vendor. For example, the consumer may purchase the product or service typically from the same vendor, so the tracking module 202 may track purchases and the order history module 302 may store the tracked purchases at a computer or data storage controlled by the vendor. In another embodiment, the order history module 302 stores the order history at a location accessible to the vendor and also to the consumer, for example on the consumer's computer 108 or a data storage device 114 accessible to the computer 108. The reorder point module 206 may use the order history stored by the order history module 302 to determine a reorder point 416. For example, the reorder point module 206 may determine a latest purchase of the product or service and apply a rate of consumption determined by the rate module 204, a safety stock level 412, replenishment lead time 422, etc. to determine a reorder point 416.

In one embodiment, the order history module 302 stores the order history on one or more cookies 110. The cookie(s) 110 may be located on a data storage device accessible to the computer 108 of the consumer. For example, the order history module 302 may store one or more cookies 110 on the hard drive of the computer 108 or a data storage device 114 accessible to the computer 108 over a computer network 106. In one embodiment, the order history module 302 stores one or more cookies 110 that are accessible only to the vendor of the product or service. For example, each time the consumer purchases the product or service from a particular vendor, the order history module 302, in conjunction with the tracking module 202, may update a cookie 110 with purchase information, such as amount ordered, product or service information, date and time of purchase, or other relevant information important to the vendor. The reorder point module 206 may then access the order history in determining a reorder point 416.

In another embodiment, the order history module 302 stores a shared cookie 110 that is accessible to other parties, such as other vendors. For example, the consumer may purchase a product or service from vendor A, and then reorder the product or service from vendor B. Vendors A and B may each use an order history module 302 to store a separate shared cookie 110. The reorder point module 206 may then access both shared cookies 110 to determine the latest purchase date and/or time and may then use the order history information to determine a reorder point 416. In another embodiment, a third party, such as a company that offers a sales platform to vendors, may access the shared cookies 110 and may use a reorder point module 206 to determine a reorder point 416. The third party may advertise to the consumer on behalf of a vendor or may offer order history information to a variety of vendors as an information gathering service or as a way to get a vendor to use the services of the third party. Each vendor or a third party may have an apparatus 200, 300 for determining a reorder point 416 and then subsequently advertising to the consumer.

In one embodiment, the apparatus 300 includes an inventory tracking module 304 that tracks an inventory of the product with an inventory tracking system. In one embodiment, the consumer may have an inventory tracking system and the inventory tracking module 304 may access the inventory tracking system to determine an inventory level 406 of the product or service. For example, the consumer may be a grocery store with an inventory tracking system and the inventory tracking module 304 may access the inventory tracking system to access an inventory level 406 of a particular product sold by the grocery store. The tracking module 202 may track a previous purchase and the rate module 204 may determine a rate of consumption based on the current inventory level 406, past inventory levels, trends, etc. and the reorder point module 206 may use information from the inventory tracking module 304 along with other information to determine a reorder point 416. One of skill in the art will recognize other ways that an inventory tracking system of a consumer may be used to determine a reorder point 416.

In another embodiment, the apparatus 300 includes an advertising change module 306 that changes focus of the advertising delivered by the advertising module 208 at the reorder point 416, the safety stock level 412, and/or the out of stock level 414. For example, the advertising change module 306 may change advertising delivered by the advertising module 208 so that one type of advertisement is delivered before or at the reorder point 416 and another advertisement is delivered after the reorder point 416. In another example, the advertising change module 306 changes advertising focus at each of the reorder point 416, the safety stock level 412, and the out of stock level 414. The advertising may offer deeper discounts at each level, a change in advertising strategy, an increased quantity offered, and the like. In one embodiment, the advertising change module 306 may change a quantity offered for sale or may change a discount based on an amount purchased, or other advertising change based on differing levels of inventory 406. One of skill in the art will recognize other ways that the advertising change module 306 may change the focus of advertising over time or based on inventory levels 406.

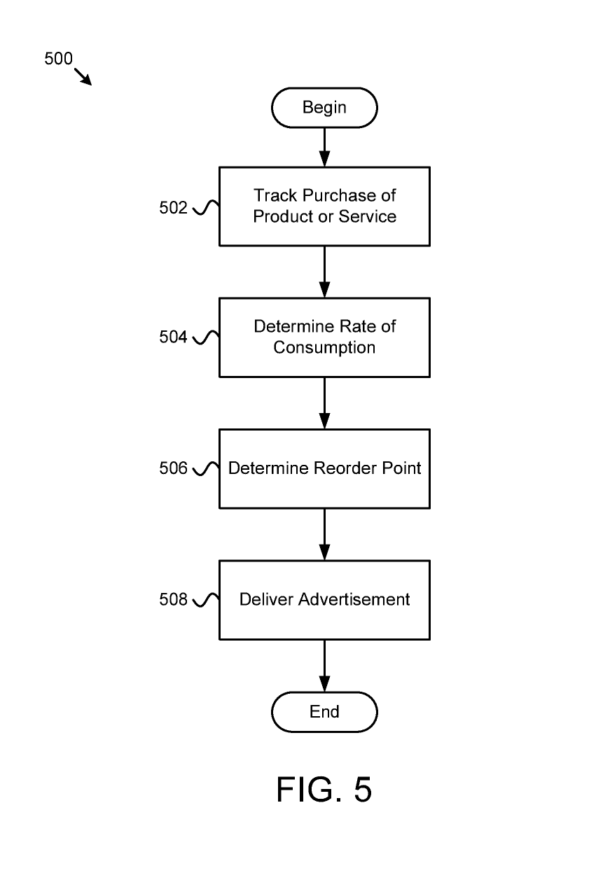

FIG. 5 is a schematic flow chart diagram illustrating one embodiment of a method 500 for determining a reorder point 416 in accordance with the present invention. The method 500 begins and tracks 502 the purchase of a product or service. In one embodiment, the tracking module 202 tracks 502 the purchase. In one embodiment, the purchase is of a quantity where an inventory level 406 of the product or service is replenished to a substantially full level. The full level may vary depending on the needs of the consumer. In one embodiment, a full level may exceed what the consumer considers to be full. In another embodiment, the consumer may purchase a product or service so that the inventory level 406 is substantially full, but not completely full.

The method 500 determines 504 a rate of consumption for the product or service. Determining 504 the rate of consumption may include reviewing an order history, determining a historical consumption rate, receiving information about consumption from the consumer, and the like. In one embodiment, the rate module 204 determines 504 the rate of consumption.

The method 500 determines 506 a reorder point 416 for the product or service. The reorder point module 206, in one embodiment, determines 506 the reorder point 416. The reorder point 416 includes an estimated time after the purchase of the product or service that is also prior to, based on the rate of consumption, the product or service inventory level 406 reaching a safety stock level 412 minus a replenishment lead time 422.

The method 500 delivers 508 an advertisement to the consumer electronically and the advertisement is delivered to the consumer at a time relative to the reorder point 416, and the method 500 ends. In one embodiment, the advertising module 208 delivers 508 the advertisement. In one embodiment, the method 500 delivers 508 the advertising just prior to the reorder point 416, at the reorder point 416, or just after the reorder point 416.

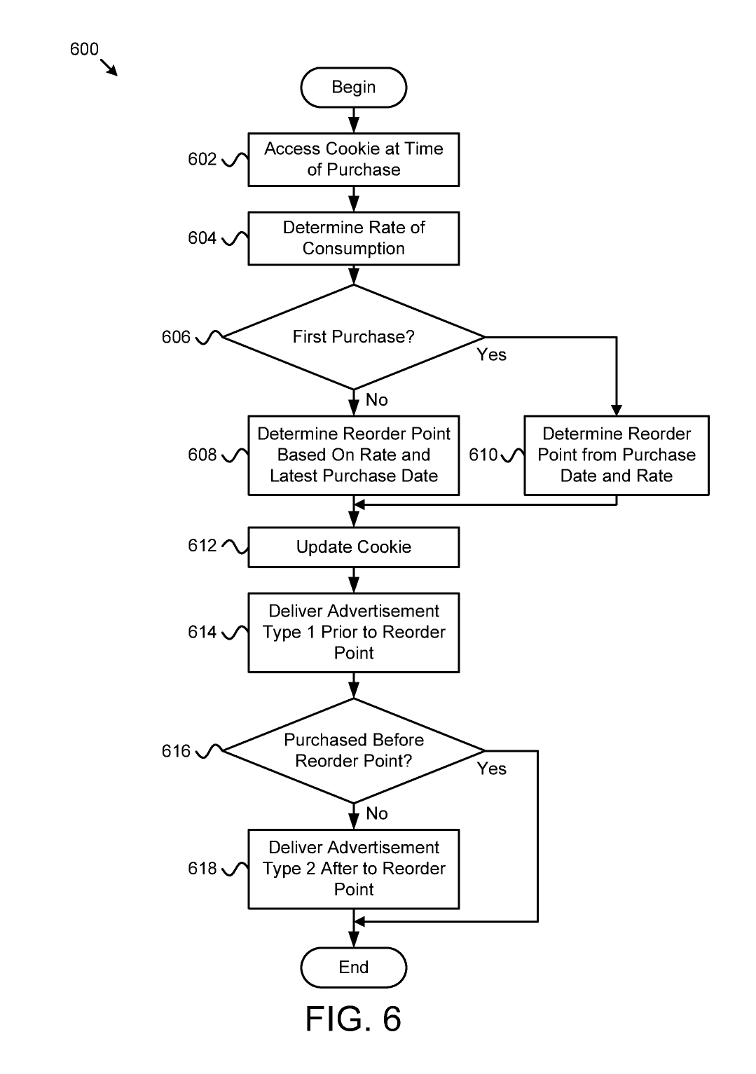

FIG. 6 is a schematic flow chart diagram illustrating another embodiment of a method 600 for determining a reorder point 416 in accordance with the present invention. The method 600 begins and tracks 602 the purchase of a product or service and determines 604 a rate of consumption. The method 600 determines 606 if the purchase is a first purchase. If the method 600 determines 606 that the purchase is a first purchase, the method 600 determines 610 a reorder point 416 from the single purchase date and rate of consumption. If the method 600 determines 606 that the purchase is not a first purchase, the method 600 determines 608 the reorder point 416 based on the rate of consumption and the latest purchase. For example, a vendor may access the vendor's own records to determine the latest purchase date. In another example, the vendor may access a cookie 110 that the vendor placed on the computer 108 of the consumer.

Where applicable, the method 600 may update 612 a cookie 110 with the purchase information. Where a vendor tracks an order history on the vendor's own system, the step of updating 612 a cookie 110 may not be executed. The method 600, in one embodiment, delivers 614 a first advertisement type prior to the reorder point 416. The method 600 determines 616 if the product or service was purchased before the reorder point 416. If the method 600 determines 616 that the product or service was purchased before the reorder point 416, the method 600 ends. If the method 600 determines 616 that the product or service was not purchased before the reorder point 416, the method 600 delivers 618 a second advertisement type to the consumer and the method 600 ends. In one embodiment, if the consumer has not purchased the product or service prior to the reorder point 416, the vendor may wish to switch to another advertising strategy, such as a more aggressive advertising strategy. The method 600, in various embodiments, may be implemented and executed with one or more of the modules 202-208, 302-306 mentioned with respect to the embodiments discussed in relation to FIGS. 2 and 3.

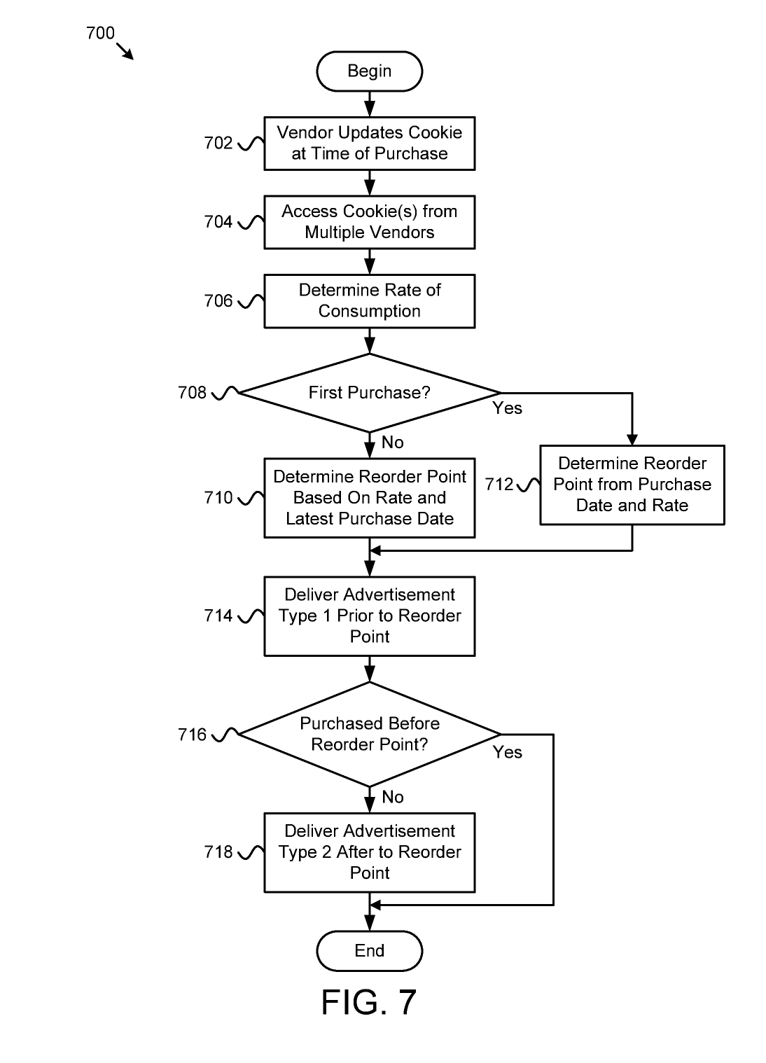

FIG. 7 is a schematic flow chart diagram illustrating another embodiment of a method 700 for determining a reorder point 416 where multiple vendors store cookies 110 in accordance with the present invention. The method 700 begins and, in one embodiment, tracks a purchase of a product or service by updating 702 a cookie 110. If the consumer did not make a purchase from the vendor, this step may not be used. The cookie 110 may be on the computer 108 of the consumer or other data storage accessible to the consumer, such as a data storage device 114 accessible through a computer network 106, maybe as part of a cloud computing system.

The method 700 accesses 704 one or more shared cookies 110, possibly from a vendor's own previous sale or a cookie 110 of other vendors to determine an order history and a latest purchase date and/or time. In one embodiment, the method 700 may use the order history from the shared cookies 110 in determining a reorder point 416. The method 700 determines 706 a rate of consumption. The method 700 determines 708 if the purchase is a first purchase. If the method 700 determines 708 that the purchase is a first purchase, the method 700 determines 712 a reorder point 416 from the single purchase date and rate of consumption. If the method 700 determines 708 that the purchase is not a first purchase, the method 700 determines 710 the reorder point 416 based on the rate of consumption and the latest purchase.

The method 700, in one embodiment, delivers 714 a first advertisement type prior to the reorder point 416. The method 700 determines 716 if the product or service was purchased before the reorder point 416. If the method 700 determines 716 that the product or service was purchased before the reorder point 416, the method 700 ends. If the method 700 determines 716 that the product or service was not purchased before the reorder point 416, the method 700 delivers 718 a second advertisement type to the consumer and the method 700 ends. The method 700, in various embodiments, may be implemented and executed with one or more of the modules 202-208, 302-306 mentioned with respect to the embodiments discussed in relation to FIGS. 2 and 3.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
tracking a purchase by a consumer of one of a product and a service, the purchase comprising a quantity so that the product or service is replenished to a substantially full level, the product or service offered for sale online, the product or service purchased by the consumer online;
determining a rate of consumption for the product or service;
determining a reorder point for the product or a service, the reorder point comprising an estimated time after the purchase of the product or service and prior to, based on the rate of consumption, the product or service reaching a safety stock level, minus a replenishment lead time, the safety stock level comprising a minimum acceptable level of one of a quantity of remaining product and service due to be delivered; and
delivering an advertisement to the consumer, the advertisement delivered to the consumer electronically, the advertisement delivered to the consumer at a time relative to the reorder point.

2. The method of claim 1, wherein tracking a purchase further comprises tracking a plurality of purchases of the product or service and storing purchase information in an order history.

3. The method of claim 2, further comprising adjusting the rate of consumption based on the order history.

4. The method of claim 2, further comprising storing the order history of the consumer on a computer readable storage medium of a vendor that sold the product or service to the consumer.

5. The method of claim 2, further comprising storing the order history of the consumer on a computer readable storage medium accessible to the consumer.

6. The method of claim 5, wherein the order history is maintained and updated with additional purchases of the product or service by the vendor selling the product or service to the consumer.

7. The method of claim 5, wherein the order history comprises purchasing the product or service from a plurality of vendors and each vendor contributes to the order history.

8. The method of claim 7, wherein each vendor contributes to the order history by one or more cookies stored on the computer readable storage medium of the consumer and wherein the cookies are shared cookies, and further comprising determining the reorder point from the order history of the shared cookies.

9. The method of claim 2, wherein tracking the order history further comprises tracking an inventory of the product with an inventory tracking system.

10. The method of claim 1, wherein determining the reorder point further comprises determining an unusable point when the product or service will no longer be usable and adjusting the reorder point if the unusable point is prior to one of the time of reaching the safety stock level and the reorder point.

11. The method of claim 1, wherein the reorder point comprises a time prior to an estimated out of stock level, the out of stock level comprising a time when one of:
the product will be completely consumed by the consumer; and
the service is completed.

12. The method of claim 11, further comprising delivering a plurality of advertisements to the consumer wherein the advertisements change focus at one or more of the reorder point, the time of reaching the safety stock level, and the out of stock level.

13. The method of claim 1, wherein delivering the advertisement to the consumer at a time relative to the reorder point comprises one or more of delivering the advertisement just prior to the reorder point, at the reorder point, and just after the reorder point.

14. The method of claim 1, wherein one of:
the product comprises a consumable product that is reordered by the consumer when the product is consumed; and
the service comprises a service delivered to the consumer over a period of time and additional service is reordered by the consumer when the service to the consumer is completed.

15. A computer program product for determining a time for advertisement delivery, the computer program product comprising a computer readable storage medium having computer readable program code embodied therein, the computer readable program code configured for:
tracking a purchase by a consumer of one of a product and a service, the purchase comprising a quantity so that the product or service is replenished to a substantially full level, the product or service offered for sale online, the product or service purchased by the consumer online;
determining a rate of consumption for the product or service;
determining a reorder point for the product or a service, the reorder point comprising an estimated time after the purchase of the product or service and prior to, based on the rate of consumption, the product or service reaching a safety stock level, minus a replenishment lead time, the safety stock level comprising a minimum acceptable level of one of a quantity of remaining product and service due to be delivered; and
delivering an advertisement to the consumer, the advertisement delivered to the consumer electronically, the advertisement delivered to the consumer at a time relative to the reorder point.

16. An apparatus comprising:
a tracking module that tracks a purchase by a consumer of one of a product and a service, the purchase comprising a quantity so that the product or service is replenished to a substantially full level, the product or service offered for sale online, the product or service purchased by the consumer online;
a rate module that determines a rate of consumption for the product or service;
a reorder point module that determines a reorder point for the product or a service, the reorder point comprising an estimated time after the purchase of the product or service and prior to, based on the rate of consumption, the product or service reaching a safety stock level, minus a replenishment lead time, the safety stock level comprising a minimum acceptable level of one of a quantity of remaining product and service due to be delivered; and
an advertising module that delivers an advertisement to the consumer, the advertisement delivered to the consumer electronically, the advertisement delivered to the consumer at a time relative to the reorder point,
wherein at least a portion of one or more of the tracking module, the rate module, the reorder point module, and the advertising module comprise one or more of hardware and executable code, the executable code stored on computer readable storage media.

17. The apparatus of claim 16, further comprising an order history module that tracks a plurality of purchases of the product or service and stores purchase information in an order history.

18. The apparatus of claim 17, wherein the order history module stores the order history on one or more of:
a computer readable storage medium of a vendor that sold the product or service to the consumer; and
a computer readable storage medium accessible to the consumer, wherein the order history module further stores the order history of the consumer on one or more cookies, the cookies accessible to one or more vendors.

19. The apparatus of claim 17, further comprising an inventory tracking module that tracks an inventory of the product with an inventory tracking system.

20. The apparatus of claim 16, further comprising a computer, the computer comprising a processor and memory, the processor executing one or more of the tracking module, the reorder point module, and the advertising module.
